(19) United States
(12) Patent Application Publication
(10) Pub. No.: US 2014/0197352 A1
(43) Pub. Date: Jul. 17, 2014

(54) METHODS AND COMPOSITIONS FOR ENERGY DISSIPATION

(71) Applicant: SABIC INNOVATIVE PLASTICS IP B.V., Bergen op zoom (NL)

(72) Inventors: Davide Louis Simone, Saratoga Springs, NY (US); Gary Stephen Balch, Ballston Spa, NY (US); David Alexander Gibson, III, Scotia, NY (US); Harold Jay Patchen, Ballston Lake, NY (US); Allen Lawrence Garner, Clifton Park, NY (US); Daniel Qi Tan, Rexford, NY (US); Francis Johnson, Clifton Park, NY (US); Gregory John Parker, San Jose, CA (US)

(73) Assignee: SABIC Innovative Plastics IP B.V., Bergen op zoom (NL)

(21) Appl. No.: 13/739,575

(22) Filed: Jan. 11, 2013

(51) Int. Cl. H01Q 15/14

(52) U.S. Cl. CPC H01Q 15/14
USPC 252/62.54

(57) ABSTRACT

A method for forming a composition exhibiting energy dissipation in at least a portion of the frequency range from about 1 GHz to about 20 GHz can comprise treating a magnetic lossy material to increase the brittleness of the material, processing at least a portion of the magnetic lossy material into a powder, and mixing at least a portion of the powder with a dielectric resin, wherein the percentage volume of the powder relative to the total volume of the composition is configured such that dissipation of incident electromagnetic radiation is substantially optimized in at least a portion of the frequency range from about 1 GHz to about 20 GHz.

### BACKGROUND

Electromagnetic (EM) radiation attenuating technology is useful for a wide variety of military and civilian applications ranging from minimizing the Radar signature of a target to EM shielding in consumer electronics. EMI (Electromagnetic Interference) shielding of electronic systems to decrease susceptibility to, and radiation from, EM sources is increasingly important in various applications, particularly at the radio to microwave wavelengths.

### SUMMARY

It is to be understood that both the following general description and the following detailed description are exemplary and explanatory only and are not restrictive, as claimed. Provided are methods and compositions for energy dissipation. As an example, the methods and compositions can optimize the absorption, reflection, transmission of powder filled composite materials over the 1-20 GHz frequency range. As a further example, the powdered filler can be Metglas® 2705M. As used herein, the Metglas® 2705M can be a magnetic material similar to the cobalt-based magnetic alloy defined by the trade name Metglas® 2705M.

In an aspect, Metglas® 2705M tape can be subjected to a cryogenic grinding process to powderize the Metglas® 2705M into particulates of less than about 250 microns in size for compounding into thermoplastics. The resulting composite material created from compounding Metglas® 2705M powder and thermoplastic can yield desirable absorption, reflection, and transmission properties in the 1-20 GHz frequency range.

In an aspect, a composition for energy dissipation behavior in at least a portion of the frequency range from about 1 GHz to about 20 GHz can comprise a dielectric and a magnetic lossy powder mixed with at least a portion of the dielectric. As an example, the percentage volume of the magnetic lossy material relative to the total volume of the composition is configured such that dissipation of incident electromagnetic radiation is substantially optimized in at least a portion of the frequency range from about 1 GHz to about 20 GHz.

In an aspect, a method for forming a composition exhibiting energy dissipation in at least a portion of the frequency range from about 1 GHz to about 20 GHz can comprise treating a magnetic lossy material to increase the brittleness of the material. At least a portion of the magnetic lossy material can be processed into a powder. At least a portion of the powder can be mixed with the dielectric resin, wherein the percentage volume of the powder relative to the total volume of the composition is configured such that dissipation of incident electromagnetic radiation is substantially optimized in at least a portion of the frequency range from about 1 GHz to about 20 GHz.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is a graphical representation of permittivity properties of exemplary compositions comprising various filler loadings of 10 vol %, 20 vol %, 30 vol %, and 40 vol % Metglas 2705M in ABS;

FIG. 2 is a graphical representation of permeability properties of exemplary compositions comprising various filler loadings of 10 vol %, 20 vol %, 30 vol %, and 40 vol % Metglas 2705M in ABS;

FIG. 3 is a graphical representation of reflection (R), absorption (A), and transmission (T) properties of exemplary compositions comprising various filler loadings of 10 vol %, 20 vol %, 30 vol %, and 40 vol %, Metglas 2705M in ABS;

FIG. 4 is a graphical representation of reflection (R), absorption (A), and transmission (T) properties of exemplary compositions comprising various filler loadings of 10 vol %, 20 vol %, 30 vol %, and 40 vol % Metglas 2705M in ABS;

FIG. 5 is a graphical representation of shielding effectiveness properties of exemplary compositions comprising various filler loadings of 10 vol %, 20 vol %, 30 vol %, and 40 vol % Metglas 2705M in ABS;

FIG. 6 is a graphical representation of shielding effectiveness properties of exemplary compositions comprising various filler loadings of 10 vol %, 20 vol %, 30 vol %, and 40 vol % Metglas 2705M in ABS; and

FIG. 7 is a graphical representation of impedance properties of exemplary compositions comprising various filler loadings of 10 vol %, 20 vol %, 30 vol %, and 40 vol % Metglas 2705M in ABS.

### DETAILED DESCRIPTION

Before the present methods and systems are disclosed and described, it is to be understood that the methods and systems are not limited to specific synthetic methods, specific components, or to particular compositions. It is also to be understood that the terminology used herein is for the purpose of describing particular embodiments only and is not intended to be limiting.

As used in the specification and the appended claims, the singular forms “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps, “Exemplary” means “an example of” and is not intended to convey an indication of a preferred or ideal embodiment. “Such as” is not used in a restrictive sense, but for explanatory purposes.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed. All ranges disclosed herein are inclusive and combinable (e.g., ranges of “up to 25 volume or, more specifically 5 volume % to 20 volume %” is inclusive of the endpoints and all intermediate values of the ranges of “5 volume % to 25 volume %,” etc.).

The terms “first,” “second,” “first part,” “second part,” and the like, where used herein, do not denote any order, quantity, or importance, and are used to distinguish one element from another, unless specifically stated otherwise.

As used herein, the terms “optional” or “optionally” means that the subsequently described event or circumstance can or can not occur, and that the description includes instances where said event or circumstance occurs and instances where it does not. For example, the phrase “optionally substituted alkyl” means that the alkyl group can or can not be substituted and that the description includes both substituted and unsubstituted alkyl groups.

As used herein, the term “effective amount” refers to an amount that is sufficient to achieve the desired modification of a physical property of the composition or material. For example, an “effective amount” of a recycled polycarbonate blend refers to an amount that is sufficient to achieve the desired improvement in the property modulated by the formulation component, e.g. splaying, under applicable test conditions and without adversely affecting other specified properties. The specific level in terms of wt % and/or volume % in a composition required as an effective amount will depend upon a variety of factors including the amount and type of recycled polycarbonate blend, amount and type of virgin polycarbonate polymer compositions, amount and type of impact modifier compositions, including virgin and recycled impact modifiers, and end use of the article made using the composition.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds can not be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific aspect or combination of aspects of the methods of the invention.

References in the specification and concluding claims to parts by weight, of a particular element or component in a composition or article, denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent of a component, unless specifically stated to the contrary, is based on the total weight of the formulation or composition in which the component is included. For example, if a particular element or component in a composition or article is said to have 8% by weight, it is understood that this percentage is relative to a total compositional percentage of 100% by weight.

References in the specification and concluding claims to parts by volume, of a particular element or component in a composition or article, denotes the volume relationship between the element or component and any other elements or components in the composition or article for which a part by volume is expressed. Thus, in a compound containing 2 parts by volume of component X and 5 parts by volume component Y, X and Y are present at a volume ratio of 2:5, and are present in such ratio regardless of whether additional components are contained in the compound.

A volume percent (vol %) of a component, unless specifically stated to the contrary, is based on the total volume of the formulation or composition in which the component is included. For example if a particular element or component in a composition or article is said to have 8% by volume, it is understood that this percentage is relative to a total compositional percentage of 100% by volume.

Compounds are described using standard nomenclature. For example, any position not substituted by any indicated group is understood to have its valence filled by a bond as indicated, or a hydrogen atom. A dash (“-”) that is not between two letters or symbols is used to indicate a point of attachment for a substituent. For example, —CHO is attached through carbon of the carbonyl group. Unless defined otherwise, technical and scientific terms used herein have the same meaning as is commonly understood by one of skill in the art to which this invention belongs.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the Examples included therein and to the Figures and their previous and following description.

In an aspect, a composition is provided for energy dissipation behavior. As an example, the energy dissipation behavior is experienced in at least a portion of the frequency range from about 1 GHz to about 20 GHz. As a further example, the composition can comprise a dielectric and a magnetic lossy material. In an aspect, the term magnetic lossy material can denote magnetic material that dissipates energy (i.e., power loss) due at least in part to hysteretic and eddy current processes. As an example, the magnetic lossy material can be powder. In an aspect, the magnetic lossy material can comprise Metglas® 2705M. As an example, the magnetic lossy powder can have an average particulate size of less than or equal to 250 microns. As a further example, the magnetic lossy powdered can have an average particulate size of less than or equal to 75 microns.

In an aspect, the dielectric can comprise a thermoplastic polymer. As an example, various thermoplastic resins such as polypropylene, polyethylene, polystyrene, polyvinyl chloride, polyacetal, polyethylene terephthalate, polycarbonate, polyvinyl acetate, polyamide, polyamide imide, polyether imide, polyether ether ketone, polyvinyl alcohol, poly phenylene ether, poly(meth)acrylate, and liquid crystal polymer; and various thermosetting resins such as epoxy resin, vinyl ester resin, phenol resin, unsaturated polyester resin, furan resins, imide resin, urethane resin, melamine resin, silicone resin and urea resin; as well as various elastomers such as natural rubber, styrene butadiene rubber (SBR), butadiene rubber (BR), polyisoprene rubber (IR), ethylene-propylene rubber (EPDM), nitrile rubber (NBR), polychloroprene rubber (CR), isobutylene isoprene rubber (IIR), polyurethane rubber, silicone rubber, fluorine rubber, acrylic rubber (ACM), epichlorohydrin rubber, ethylene acrylic rubber, norbornene rubber, and thermoplastic elastomer can be enumerated as the dielectric. Furthermore, the dielectric may be in various forms of composition, such as adhesive, fibers, paint, ink, etc. As a further example, the dielectric can comprise acrylonitrile butadiene styrene. As used herein, the term “ABS” or “acrylonitrile-butadiene-styrene copolymer” refers to an acrylonitrile-butadiene-styrene polymer which can be an acrylonitrile-butadiene-styrene terpolymer or a blend of styrene-butadiene rubber and styrene-acrylonitrile copolymer.

In an aspect, the magnetic lossy material can be mixed with at least a portion of the dielectric. As an example, the percentage volume of the magnetic lossy material relative to the total volume of the composition can be configured such that dissipation of incident electromagnetic radiation is substantially optimized in at least a portion of the frequency range from about 1 GHz to about 20 GHz. Optimization of dissipation of radiation can comprise substantially maximizing the dissipation effect of one or more of absorption and reflection. Optimization of dissipation of radiation can comprise substantially minimizing transmission of electromagnetic radiation.

In an aspect, the percentage volume of the magnetic lossy material (e.g., powder) relative to the total volume of the composition can be from about 10% to about 40%. As an example, the percentage volume of the magnetic lossy material (e.g. powder) relative to the total volume of the composition can be from about 30% to about 40%. As a further example, the percentage volume of the magnetic lossy material (e.g., powder) relative to the total volume of the composition is from about 10% to about 20%.

As an example, the percentage volume (vol %) of the dielectric relative to the total volume of the composition can be from about 60% to about 90%. As another example, the percentage volume of the dielectric relative to the total volume of the composition can be from about 60% to about 70%. As a further example, the percentage volume of the dielectric relative to the total volume of the composition can be from about 80% to about 90%.

In an aspect, a thickness of the composition can be configured to minimize transmission of the incident electromagnetic radiation. In another aspect, a percentage volume of the magnetic lossy powder relative to the total volume of the composition can be configured such that one or more of a reflection, absorption, and transmission of electromagnetic radiation incident to the composition is substantially optimized in at least a portion of the frequency range from about 1 GHz to about 20 GHz.

In an aspect, a method for forming a composition exhibiting energy dissipation in at least a portion of the frequency range from about 1 Hz to about 20 GHz can comprise treating a magnetic lossy material to increase the brittleness of the material. As an example, treating the magnetic lossy material can comprise heat treating. As another example, treating the magnetic lossy material can comprise inducing substantial crystallization of at least a portion of the magnetic lossy material. In an aspect, heat treating can be performed from about 300 C to about 500 C. As an example, heat treating can be performed from about 300 C to about 400 C. As a further example, heat treating can be performed at about 350 C.

In an aspect, at least a portion of the magnetic lossy material can be processed into a powder. As an example, processing at least a portion of the magnetic lossy material can comprise grinding. As a further example, processing at least a portion of the magnetic lossy material can comprise cryogenic grinding.

In an aspect, at least a portion of the powder magnetic lossy material can be filtered. As an example, the filtered powder can have an average particulate size of less than or equal to 250 microns. As a further example, the filtered powder can have an average particulate size of less than or equal to 75 microns.

At least a portion of the powder can be mixed with a dielectric resin. As an example, the percentage volume of the powder relative to the total volume of the composition is configured such that dissipation of incident electromagnetic radiation is substantially optimized in at least a portion of the frequency range from about 1 GHz to about 20 GHz.

Further preparation of the compositions can be performed in accordance with any known method by selecting an optimal method depending on the kind of the dielectric and/or conductive material used, for instance, in the case of a thermoplastic polymer, it may be accomplished by kneading under melted condition, dispersion, extrusion, and the like. Further preparation can comprise mixing the powder with the dielectric. The thus obtained compositions according to the present disclosure can remarkably reduce the influence of the electromagnetic waves, when it is processed into a film, a layered material, and/or a casing product for any apparatus and it is used at an appropriate place.

The present disclosure comprises at least the following embodiments.

### Embodiment 1

A method for forming a composition exhibiting energy dissipation in at least a portion of the frequency range from about 1 GHz to about 20 GHz, the method comprising: treating a magnetic lossy material to increase the brittleness of the material; processing at least a portion of the magnetic lossy material into a powder; and mixing at least a portion of the powder with a dielectric resin, wherein the percentage volume of the powder relative to the total volume of the composition is configured such that dissipation of incident electromagnetic radiation is substantially optimized in at least a portion of the frequency range from about 1 GHz to about 20 GHz.

### Embodiment 2

The method of embodiment 1, wherein treating the magnetic lossy material comprises heat treating.

### Embodiment 3

The method of embodiment 1, wherein treating the magnetic lossy material comprises inducing substantial crystallization of at least a portion of the magnetic lossy material.

### Embodiment 4

The method of any of embodiments 1-3, wherein the treating is performed at about 350 C.

### Embodiment 5

The method of any of embodiments 1-4, wherein the magnetic lossy material comprises Metglas 2705M.

### Embodiment 6

The method of any of embodiments 1-4, wherein the magnetic lossy material comprises Metglas 2705M ribbon.

### Embodiment 7

The method of any of embodiments 1-6, wherein processing at east a portion of the magnetic lossy material comprises grinding.

### Embodiment 8

The method of any of embodiments 1-6, wherein processing at least a portion of the magnetic lossy material comprises cryogenic grinding.

### Embodiment 9

The method of any of embodiments 1-8, further comprising filtering at least a portion of the powder.

### Embodiment 10

The method of embodiment c, wherein the filtered powder has an average particulate size of less than or equal to 250 microns.

### Embodiment 11

The method of embodiment 9, wherein the filtered powder as an average particulate size of less than or equal to 75 microns.

### Embodiment 12

The method of any of embodiments 1-11, wherein the dielectric resin comprises a thermoplastic resin.

### Embodiment 13

The method of any of embodiments 1-12, wherein the percentage volume of the powder relative to the total volume of the composition is from about 10% to about 40%.

### Embodiment 14

The method of any of embodiments 1-12, wherein the percentage volume of the powder relative to the total volume of the composition is from about 30% to about 40%.

### Embodiment 15

The method of any of embodiments 1-12, wherein the percentage volume of the powder relative to the total volume of the composition is from about 10% to about 20%.

### Embodiment 16

A composition for energy dissipation behavior in at least a portion of the frequency range from about 1 GHz to about 20 GHz, the composition comprising: a dielectric; and a magnetic lossy powder mixed with at least a portion of the dielectric, wherein the percentage volume of the magnetic lossy material relative to the total volume of the composition is configured such that dissipation of incident electromagnetic radiation is substantially optimized in at least a portion of the frequency range from about 1 GHz to about 20 GHz.

### Embodiment 17

The composition of embodiment 16, wherein the magnetic lossy powder comprises Metglas 2705M.

### Embodiment 18

The composition of any of embodiments 16-17, wherein the magnetic lossy powder has an average particulate size of less than or equal to 250 microns.

### Embodiment 19

The composition of any of embodiments 16-17, wherein the magnetic lossy powder has an average particulate size of less than or equal to 75 microns.

### Embodiment 20

The composition of any of embodiments 16-9 wherein the dielectric comprises a thermoplastic polymer.

### Embodiment 21

The composition of any of embodiments 16-20, wherein the percentage volume of the magnetic lossy powder relative to the total volume of the composition is from about 10% to about 40%.

### Embodiment 22

The composition of any of embodiments 16-20, wherein the percentage volume of the magnetic lossy powder relative to the total volume of the composition is from about 30% to about 40%.

### Embodiment 23

The composition of any of embodiments 16-20, wherein the percentage volume of the magnetic lossy powder relative to the total volume of the composition is from about 10% to about 20%.

### Embodiment 24

The composition of any of embodiments 16-23, wherein a thickness of the composition is configured to minimize transmission of the incident electromagnetic radiation.

### Embodiment 25

The composition of any of embodiments 16-24, wherein a percentage volume of the magnetic lossy powder relative to the total volume of the composition is configured such that one or more of a reflection, absorption, and transmission of electromagnetic radiation incident to the composition is substantially optimized in at least a portion of the frequency range from about 1 GHz to about 20 GHz.

In an aspect, the thus obtained compositions according to the present disclosure can be used to form an enclosure for protecting circuit boards from EM radiation or to protect other electronics from exposure to EM radiation emitted by a discrete electronic component or components. As an example, an enclosure can have any shape that can be molded and can enclose electronic boards (“macroscopic” use) or discrete components (“microscopic use”). Example applications comprise enclosures such as cell phone housings, laptop housings, aircraft skeleta or skin, automobile electronic housings for boards and components, healthcare and related electronics (MRI housings, pacemaker housings), and the like.

### Examples

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the scope of the methods and systems. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

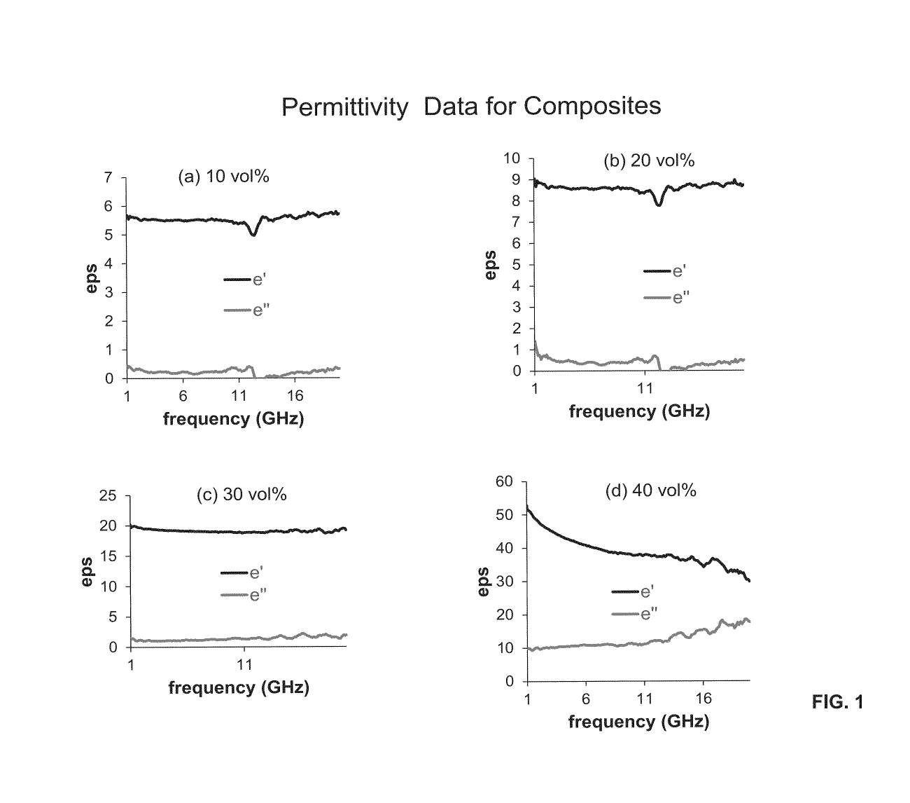

The compositions of the present disclosure can be manufactured by various methods. The compositions of the present disclosure can be blended with the aforementioned ingredients by a variety of methods involving intimate admixing of the materials with any additional additives desired in the formulation. In an aspect, the composition can be extruded in accordance with one or more of the specifications illustrated in FIG. 1.

As illustrated in Table 1, an exemplary 10 vol % Metglas 2705M flake filler composition comprising about 185.7 g ABS and about 154.8 g of Metglas 2705M flake was blended using a two screw extruder.

TABLE 1

| screw design | twin screw feeder #3 (S/N 920931) - mild mixing | |
|---|---|---|
| material | ABS Cycolac MG47F-NA1000 w/Metglas 2705M | |
| | under 75 u alloy flake at 10 vol % extrudate | |
| trial # | 1 | |
| melt temp (C.) | 205 | |
| | set | act |
| temp - zone 1 (feed) | 220 | 219.7 |
| temp - zone 2 | 220 | 220.1 |
| temp - zone 3 | 220 | 220.7 |
| temp - zone 4 | 220 | 220.3 |
| temp - zone 5 | 220 | 220.9 |
| temp - zone 6 (die) | | |

| | |
|---|---|
| RPM | 300 |
| torque (%) | 10.2 |
| die PSI | 206 |
| throughput (set) | 4 lb/hr |
| throughput (act) | 4.0655 |

As illustrated in Table 2, an exemplary 20 vol % Metglas 2705M flake filler composition comprising about 158.2 g ABS and about 296.2 g of Metglas 2705M flake was blended using a two screw extruder.

TABLE 2

| screw design | twin screw feeder #3 (S/N 920931) - mild mixing | |
|---|---|---|
| material | ABS Cycolac MG47F-NA1000 w/Metglas 2705M | |
| | under 75 u alloy flake at 20 vol % extrudate | |
| trial # | 1 | |
| melt temp (C.) | 209 | |
| | set | act |
| temp - zone 1 (feed) | 220 | 220.5 |
| temp - zone 2 | 220 | 220.2 |
| temp - zone 3 | 220 | 220.1 |
| temp - zone 4 | 220 | 220.1 |
| temp - zone 5 | 220 | 221.0 |
| temp - zone 6 (die) | | |

| | |
|---|---|
| RPM | 300 |
| torque (%) | 10.2 |
| die PSI | 207 |
| throughput (set) | 4 lb/hr |
| throughput (act) | 4.0477 |

As illustrated in Table 3, an exemplary 30 vol % Metglas 2705M flake filler composition comprising about 107.9 g ABS and about 346.4 g of Metglas 2705M flake was blended using a two screw extruder.

TABLE 3

| screw design | twin screw feeder #3 (S/N 920931) - mild mixing | |
|---|---|---|
| material | ABS Cycolac MG47F-NA1000 w/Metglas 2705M | |
| | under 75 u alloy flake at 30 vol % extrudate | |
| trial # | 1 | |
| melt temp (C.) | 213 | |
| | set | act |
| temp - zone 1 (feed) | 230 | 230.3 |
| temp - zone 2 | 230 | 229.9 |
| temp - zone 3 | 230 | 230.3 |
| temp - zone 4 | 230 | 230.3 |
| temp - zone 5 | 230 | 229.7 |
| temp - zone 6 (die) | | |

| | |
|---|---|
| RPM | 300 |
| torque (%) | 191.0 |
| die PSI | 9.8 |
| throughput (set) | 4 lb/hr |
| throughput (act) | 4.2203 |

As illustrated in Table 4, an exemplary 40 vol % Metglas 2705M flake filler composition comprising about 75.9 g ABS and about 378.7 g of Metglas 2705M flake was blended using a two screw extruder.

TABLE 4

| screw design | twin screw feeder #3 (S/N 920931) - mild mixing | |
|---|---|---|
| material | ABS Cycolac MG47F-NA1000 w/Metglas 2705M | |
| | under 75 u alloy flake at 40 vol % extrudate | |
| trial # | 1 | |
| melt temp (C.) | 225 | |
| | set | act |
| temp - zone 1 (feed) | 240 | 240.3 |
| temp - zone 2 | 240 | 240.1 |
| temp - zone 3 | 240 | 240.4 |
| temp - zone 4 | 240 | 240.0 |
| temp - zone 5 | 240 | 240.1 |
| temp - zone 6 (die) | | |

| | |
|---|---|
| RPM | 300 |
| torque (%) | 9.3 |
| die PSI | 206 |
| throughput (set) | 4 lb/hr |
| throughput (act) | 4.0179 |

In an aspect, the extrusion extrudate from the blending process illustrated in one or more of Tables 1-4 was compression molded. As an example, compression molding was facilitated by a Tetrahedron MTP-14 press. As a further example, the press was set to about 395 F (˜201 C). Accordingly, at desired temp, the composition extrudate was placed in a mold, covered with steel plates, and inserted in the press. Platens can be closed with about 0 lbs force. At the set temperature, with about 0 lbs force, manually compression was provided for a set time (e.g., about 10 min). Press force was increased to about 1000 lbs for about 5 min. Press force was further increased to about 5000 lbs for about 5 min. Press force was further increased to about 10,000 lbs for about 5 min. The press was cooled to a set cooling temperature (e.g., about 180 F) under pressure and the compression molded composition was removed.

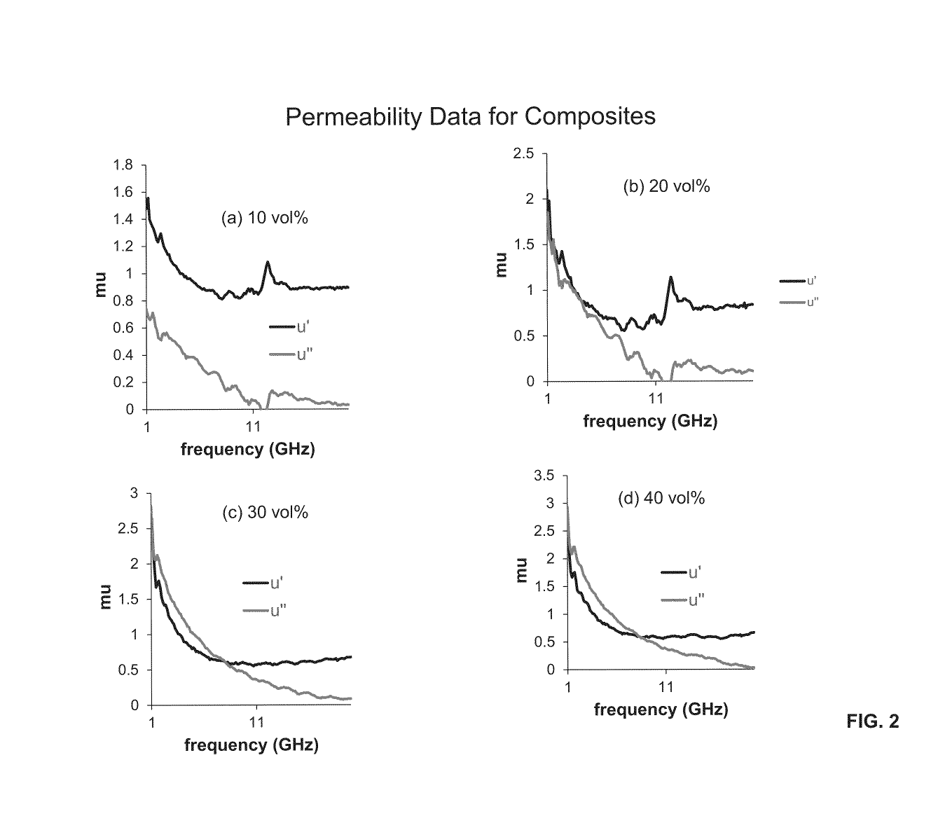

FIGS. 1-2 illustrate graphical representations of permittivity and permeability properties of an exemplary compositions, respectively. As shown, the exemplary composite comprises various filler loadings of 10 vol %, 20 vol %, 30 vol %, and 40 vol % Metglas 2705M in ABS. In an aspect, increases in the volume loading from 10 vol % to 40 vol % indicate an increase in real and imaginary permittivity. As an example, a contributor to the permittivity loss is via electrical conduction percolation through the composite. As a further example, the real and imaginary permeability of the composite can also vary with increased loading.

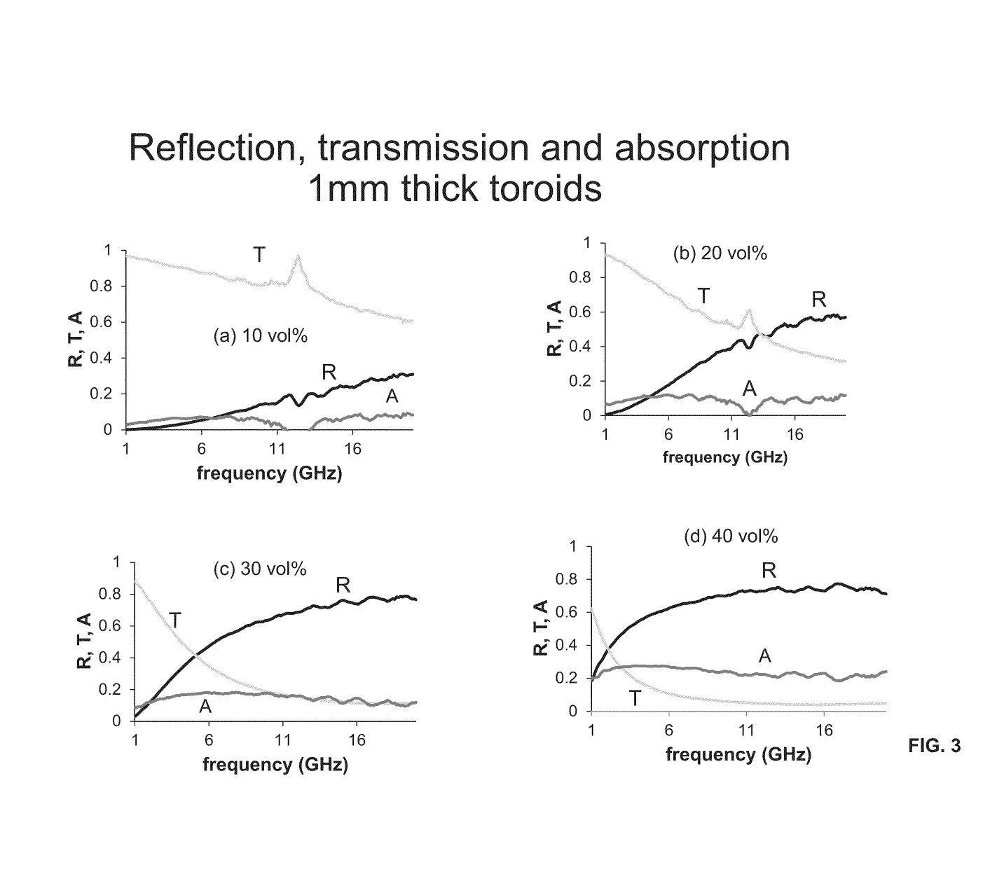

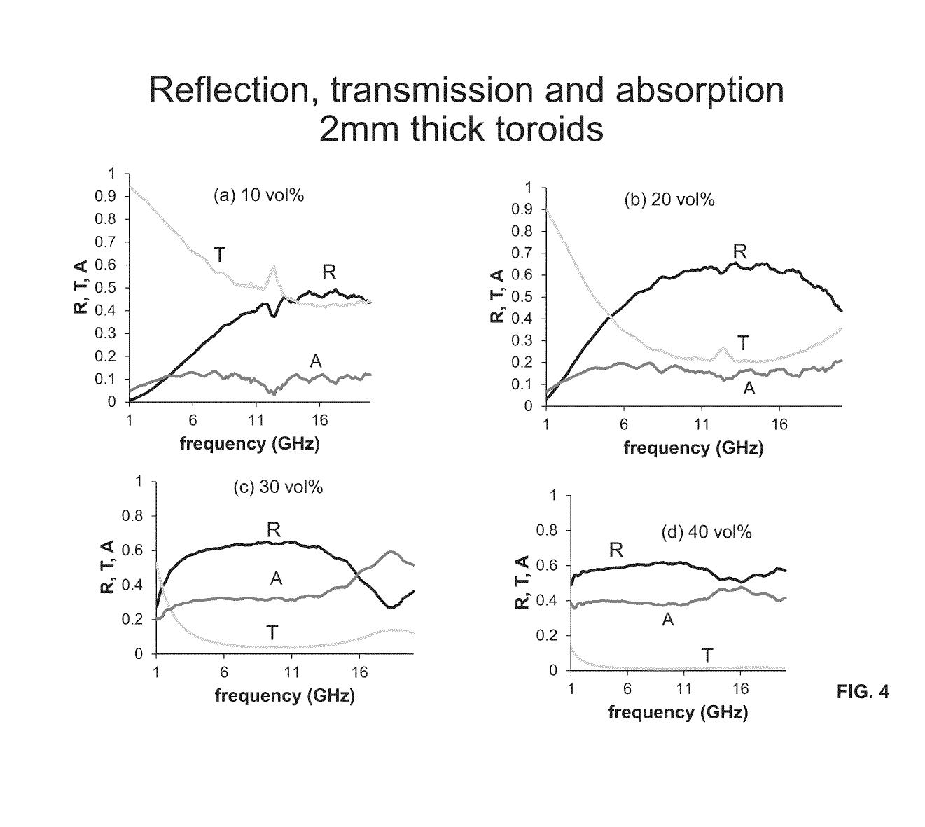

FIGS. 3-4 illustrate graphical representations of reflection (R), absorption (A), and transmission (T) properties of exemplary compositions prepared in accordance with Tables 1-4 and having 1 mm thickness and 2 mm thickness, respectively. In an aspect, increases in volume loading of the Metglas® 2705M powder into ABS resin can yield an increase in reflection and absorption with a concurrent drop in transmission over the 1 GHz to 20 GHz range. As an example, composition samples having 2 mm thickness demonstrate lower transmission values relative to thinner composition samples having loam thickness due in part to increasing the path length for an EM wave to be reflected, re-reflected, and absorbed. Accordingly, varying thickness of a composition can be used to manipulate transmission of the composition.

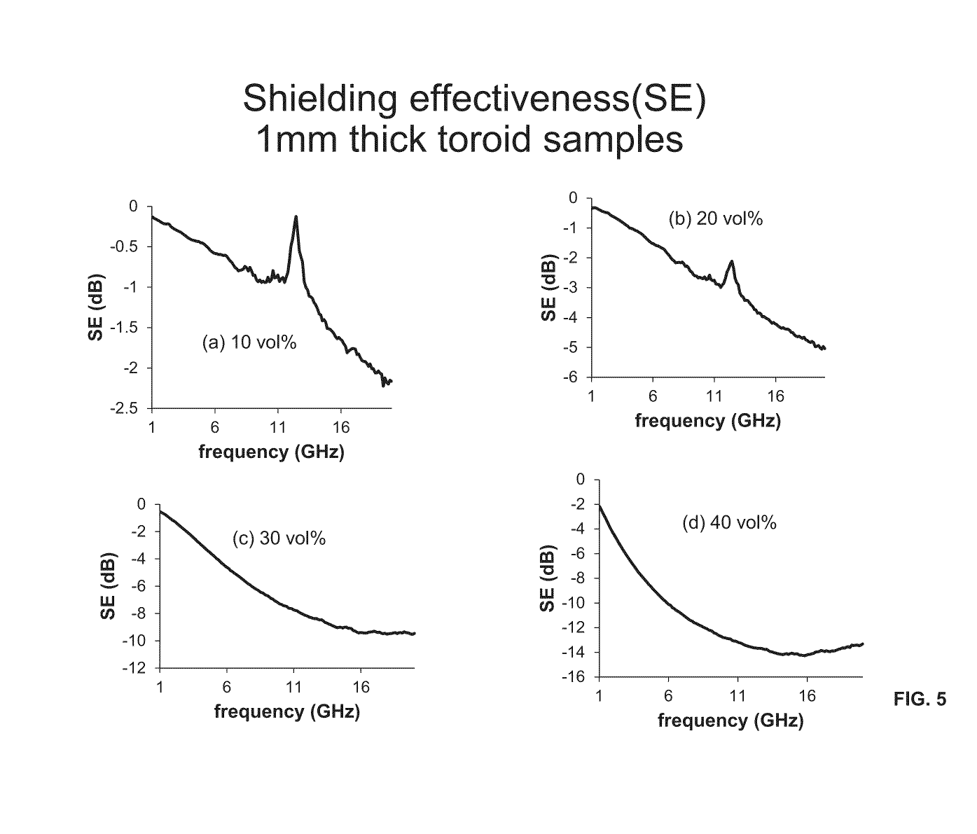

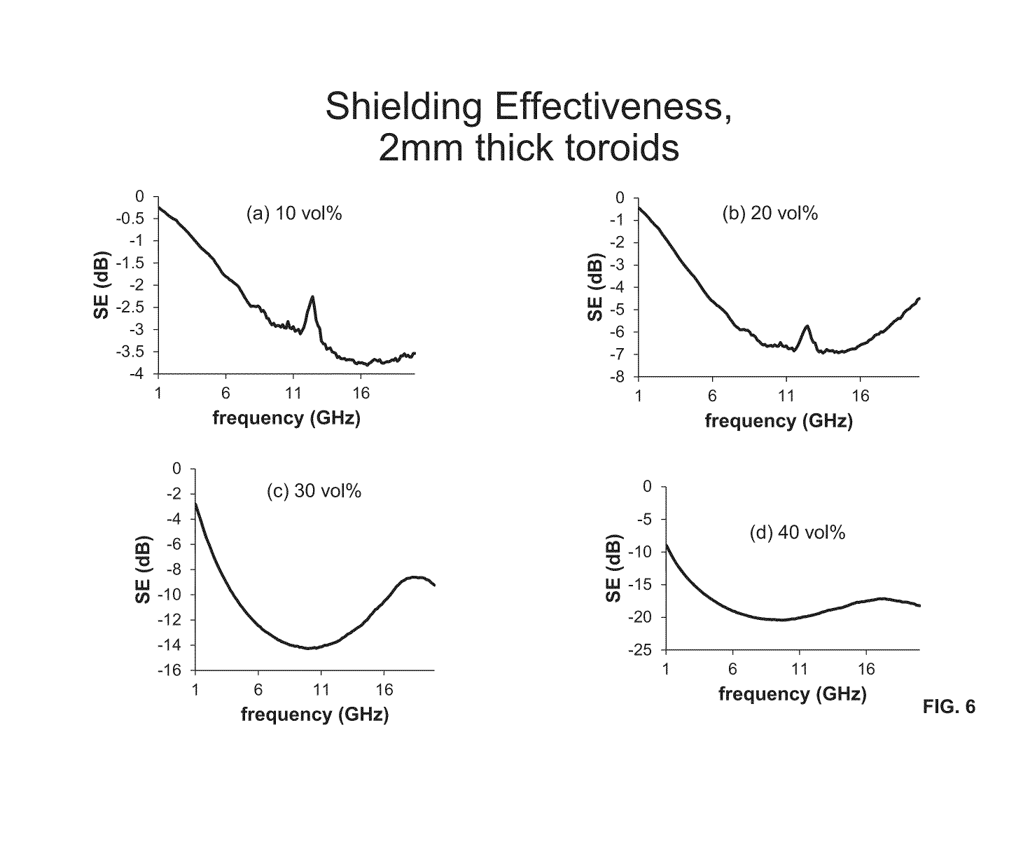

In an aspect, transmission can be quantified via shielding effectiveness calculations from reflection, absorption, and/or transmission data, as shown in FIGS. 5-6. In particular, FIGS. 5-6 illustrate graphical representations of shielding effectiveness properties of exemplary compositions prepared in accordance with Tables 1-4 and having 1 mm thickness and 2 mm thickness, respectively. In an aspect at 40 vol. % Metglas 2705M in ABS the shielding effectiveness is at −15 dB or 97% attenuation of the incoming EM wave. As an example, at high loadings (30-40 vol %), the shielding effectiveness of the compositions of differing thickness are substantially identical, indicating saturation of the composite with enough filler such that surface reflection dominates versus through sample re-reflection and absorption.

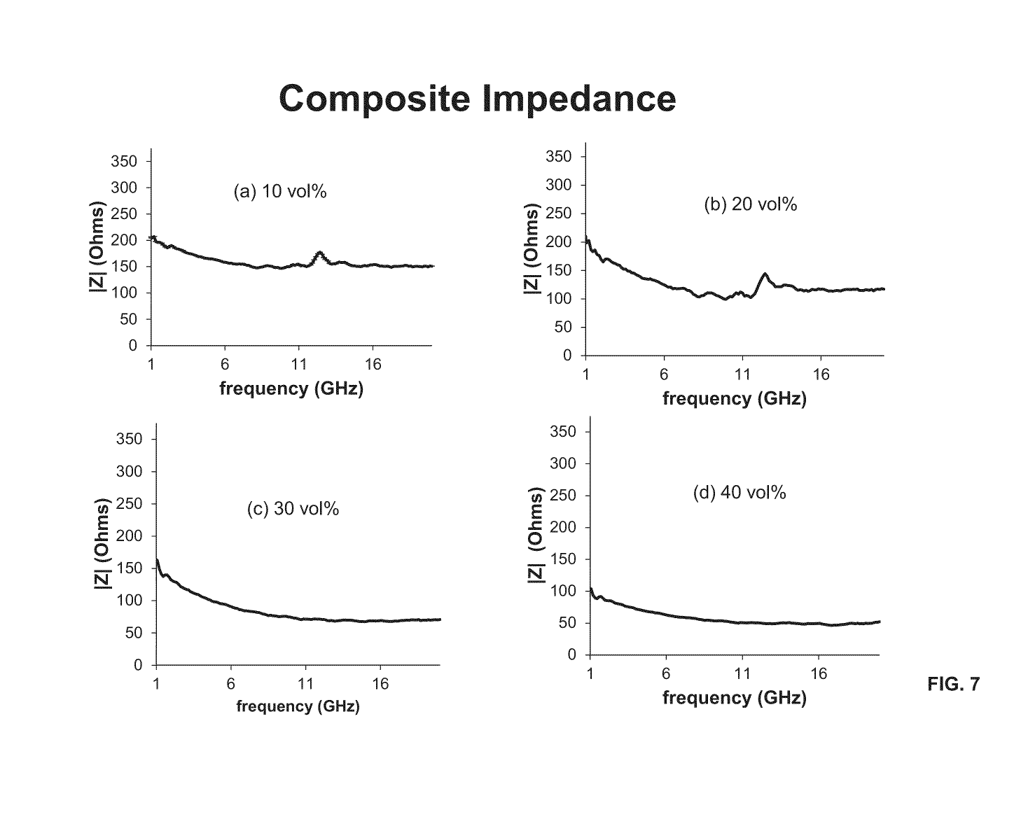

In an aspect, saturation behavior can be further verified by comparing impedance data for samples of varying thickness and volume loading, as shown in FIG. 7. In particular, FIG. 7 illustrates a graphical representation of impedance properties of exemplary compositions prepared in accordance with Tables 1-4. In an aspect, for compositions samples with high loadings of magnetic lossy filler (30-40 vol %), the impedance of the composite at 1 mm thickness and 2 mm thickness are substantially similar, indicating that the surface reflectivity is high for both thicknesses. As a point of reference, a composite with an impedance of 377 ohms, the impedance of free space, would allow for complete transmission of EM waves the thickness of the composite. The smaller the impedance value the greater the surface reflection. At lower volume loadings (10-20 vol %), electrical percolation less likely and the compositions become more transmissive, thereby requiring greater thickness in order to decrease transmission comparable to higher volume loaded samples.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

Throughout this application, various publications are referenced. The disclosures of these publications in their entireties are hereby incorporated by reference into this application in order to more fully describe the state of the art to which the methods and systems pertain.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method for fanning a composition exhibiting energy dissipation in at least a portion of the frequency range from about 1 GHz to about 20 GHz, the method comprising:
treating a magnetic lossy material to increase the brittleness of the material;
processing at least a portion of the magnetic lossy material into a powder; and
mixing at least a portion of the powder with a dielectric resin, wherein the percentage volume of the powder relative to the total volume of the composition is configured such that dissipation of incident electromagnetic radiation is substantially optimized in at least a portion of the frequency range from about 1 GHz to about 20 GHz.

2. The method of claim 1, wherein treating the magnetic lossy material comprises heat treating.

3. The method of claim 1, wherein treating the magnetic lossy material comprises inducing substantial crystallization of at least a portion of the magnetic lossy material.

4. The method of claim 1, wherein the heat treating is performed at about 350 C.

5. The method of claim 1, wherein the magnetic lossy material comprises Metglas 2705M.

6. The method of claim 1, wherein the magnetic lossy material comprises Metglas 2705M ribbon.

7. The method of claim 1, wherein processing at least a portion of the magnetic, lossy material comprises grinding.

8. The method of claim 1, wherein processing at least a portion of the magnetic lossy material comprises cryogenic grinding.

9. The method of claim 1, further comprising filtering at least a portion of the powder.

10. The method of claim 9, wherein the filtered powder has an average particulate size of less than or equal to 250 microns.

11. The method of claim 9, wherein the filtered powder has an average particulate size of less than or equal to 75 microns.

12. The method of claim 1, wherein the dielectric resin comprises a thermoplastic resin.

13. The method of claim 1, wherein the percentage volume of the powder relative to the total volume of the composition is from about 10% to about 40%.

14. The method of claim 1, wherein the percentage volume of the powder relative to the total volume of the composition is from about 30% to about 40%.

15. The method of claim 1, wherein the percentage volume of the powder relative to the total volume of the composition is from about 10% to about 20%.

16. A composition for energy dissipation behavior in at least a portion of the frequency range from about 1 GHz to about 20 GHz, the composition comprising:
a dielectric; and
a magnetic lossy powder mixed with at least a portion of the dielectric, wherein the percentage volume of the magnetic lossy material relative to the total volume of the composition is configured such that dissipation of incident electromagnetic radiation is substantially optimized in at least a portion of the frequency range from about 1 GHz to about 20 GHz.

17. The composition of claim 16, wherein the magnetic lossy powder comprises Metglas 2705M.

18. The composition of claim 16, wherein the magnetic lossy powder has an average particulate size of less than or equal to 250 microns.

19. The composition of claim 16, wherein the magnetic lossy powder has an average particulate size of less than or equal to 75 microns.

20. The composition of claim 16, wherein the dielectric comprises a thermoplastic polymer.

21. The composition of claim 16, wherein the percentage volume of the magnetic lossy powder relative to the total volume of the composition is from about 10% to about 40%.

22. The composition of claim 16, wherein percentage volume of the magnetic lossy powder relative to the total volume of the composition is from about 30% to about 40%.

23. The composition of claim 16, wherein the percentage volume of the magnetic, lossy powder relative to the total volume of the composition is from about 10% to about 20%.

24. The composition of claim 16, wherein a thickness of the composition is configured to minimize transmission of the incident electromagnetic radiation.

25. The composition of claim 16, wherein a percentage volume of the magnetic lossy powder relative to the total volume of the composition is configured such that one or more of a reflection, absorption, and transmission of electromagnetic radiation incident to the composition is substantially optimized in at least a portion of the frequency range from about 1 GHz to about 20 GHz.
